(19) United States
(12) Patent Application Publication
(10) Pub. No.: US 2026/0090865 A1
(43) Pub. Date: Apr. 2, 2026

(54) CALIBRATED DENTAL ARCH IMAGES AND JIGS

(71) Applicant: The Regents of the University of Michigan, Ann Arbor, MI (US)

(72) Inventors: Junying LI, Ann Arbor, MI (US); Zhaozhao CHEN, Ann Arbor, MI (US); Hom-Lay WANG, Ann Arbor, MI (US)

(21) Appl. No.: 19/331,098

(22) Filed: Sep. 17, 2025

Related U.S. Application Data
(60) Provisional application No. 63/700,325, filed on Sep. 27, 2024.
(60) Provisional application No. 63/723,323, filed on Nov. 21, 2024.

(51) Int. Cl. A61C 9/00; A61C 8/00; G06T 7/00; G06T 15/20

(52) U.S. Cl. CPC A61C 9/0046; A61C 8/0001; G06T 7/0012; G06T 15/205; G06T 2207/30036; G06T 2219/2004

(57) ABSTRACT

Provided herein are articles, systems, kits, and methods for generating calibrated dental arch images by processing intraoral scanning images and a dental arch calibration jig image (e.g., generated as a single image without stitches). In certain embodiments, a library of intraoral scanning images are generated by scanning a dental arch calibration jig in a subject's mouth. In particular embodiments, at least some of the first library of images of the calibration jig are stitched together to generate a stitched intraoral scan 3D jig image, at least a portion of which is spatially aligned to at least a portion of said 3D dental arch calibration jig image to generate a calibrated dental arch image.

The present application claims priority to U.S. Provisional application Ser. No. 63/700,325, filed Sep. 27, 2024, and U.S. Provisional application Ser. No. 63/723,323, filed Nov. 21, 2024, both of which are herein incorporated by reference in their entireties.

### FIELD OF THE INVENTION

Provided herein are articles, systems, kits, and methods for generating calibrated dental arch images by processing intraoral scanning images and a dental arch calibration jig image (e.g., generated as a single image without stitches). In certain embodiments, a library of intraoral scanning images are generated by scanning a dental arch calibration jig in a subject's mouth. In particular embodiments, at least some of the first library of images of the calibration jig are stitched together to generate a stitched intraoral scan 3D jig image, at least a portion of which is spatially aligned to at least a portion of said 3D dental arch calibration jig image to generate a calibrated dental arch image.

### BACKGROUND OF THE INVENTION

The fabrication of full-arch implant-supported fixed dentures or other prosthesis requires an accurate dental implant impression. A dental implant impression is a procedure used to create an exact replica of the position of dental implant(s) in the mouth. This exact replica is then used in fabricating the dentures, so they can be installed on the dental implants. The accuracy between the positions of the implant(s) in the replica, versus the actual locations of the implant(s) in the mouth, determines how well the dentures fit.

Conventionally, dental implant impressions for full-arch implant-supported dentures are obtained by using silicone-based materials to make a mold (impression) from patient's mouth, then a replica is made using gypsum placed into the mold (impression). While this conventional approach is easy to learn and has good accuracy, it causes discomfort and mess, and prolongs waiting time in the dental office.

Intraoral scanners (IOS) have been increasingly used in dental clinics for impressions of inlays, crowns, bridges, single implant crowns, and short-span implant bridges. These types of dental prostheses are relatively small and do not require attachment to more than one or two implants. IOS has sufficient accuracy for these types of dental prostheses.

In contrast, a full-arch dental implant may use multiple (e.g. 4, 6, or 8) implants. Making a custom full-arch dental implant-supported prosthesis for a patient requires measuring the locations of all the multiple implants in the patient's mouth, and then fabricating the prosthesis to precisely fit onto all those multiple implants. This requires an impression with much higher accuracy (compared to relatively small prostheses) since the prosthesis must match all those implant locations (attachment points) accurately relative to each other. Further, patients requiring full-arch dental implants are typically missing most or all of the teeth in that area, and IOS scanners can lose their position when scanning only gum tissue.

IOS does not provide adequate accuracy for full-arch implant impressions. One reason is stitching error introduced during the process of obtaining the IOS scan. For this reason, most dentists still use conventional impression techniques to obtain sufficiently accurate full-arch implant impressions. While specialized commercial photogrammetry devices (e.g. iCAM4D) can provide adequate full-arch implant impressions, they cost around $20,000 (plus the IOS device) and they are single-purpose devices used only for full-arch implant impressions.

What is needed are improved methods and apparatus for obtaining full-arch dental implant impressions using IOS with sufficient accuracy and with enhanced performance and lower cost compared to photogrammetry or other prior art methods, to improve patient experience, reduce treatment times, and improve treatment planning efficiency.

### SUMMARY OF THE INVENTION

Provided herein are articles, systems, kits, and methods for generating calibrated dental arch images by processing intraoral scanning images and a dental arch calibration jig image (e.g., generated as a single image without stitches). In certain embodiments, a library of intraoral scanning images are generated by scanning a dental arch calibration jig in a subject's mouth. In particular embodiments, at least some of the first library of images of the calibration jig are stitched together to generate a stitched intraoral scan 3D jig image, at least a portion of which is spatially aligned to at least a portion of said 3D dental arch calibration jig image to generate a calibrated dental arch image.

In some embodiments, provided herein are methods of generating a calibrated dental arch image comprising: a) receiving intraoral scan data, wherein the intraoral scan data is generated by an intraoral scanner scanning a dental arch calibration jig: i) on at least part of (e.g., 25% . . . 50% . . . 75% . . . or 100%), and optionally attached to, an edentulous area of an dental arch of a subject that has a plurality of scan bodies attached to dental implants, ii) attached to a stackable base template that is attached to a stackable implant guide template, where the stackable base template is on, and attached to, said at least part of the edentulous area of the dental arch of the subject, or iii) attached to the stackable implant guide, wherein the intraoral scan data comprises a first library of images of the calibration jig, wherein at least some of the images of the calibration jig further comprise an image of at least one of the scan bodies; b) inputting the intraoral scan data into a processing system comprising a database, wherein the database comprises 3D calibration scan data, wherein the 3D calibration scan data is from a 3D scanner scanning the dental arch calibration jig, or replica thereof, and wherein the 3D calibration scan data comprises at least part of (e.g., 30% . . . 50% . . . 75% . . . or 100%) a 3D dental arch calibration jig image (e.g., which is a single image with no stitches), wherein the processing system further comprises: i) a computer processor, and ii) non-transitory computer memory comprising one or more computer programs, c) processing the intraoral scan data and the 3D calibration scan data with the processing system such that the one or more computer programs, in conjunction with the computer processor: i) stitches together at least some of (e.g., 50% . . . 75% . . . or 100%) the first library of images of the calibration jig to generate an stitched intraoral scan 3D jig image of at least a first region of the dental arch calibration jig, wherein the stitched intraoral scan 3D jig image comprises a plurality of stitching errors; and ii) spatially aligning at least a portion of the stitched intraoral scan 3D jig image (e.g., one-half, one-sixth, one-fourth, etc.) with the 3D dental arch calibration jig image to generate a calibrated dental arch image.

In particular embodiments, provided herein are processing systems comprising: a) a computer processor, b) non-transitory computer memory comprising a database and one or more computer programs, wherein the database comprises: i) intraoral scan data that is from an intraoral scanner (or other scanning device) scanning a dental arch calibration jig: A) on, and optionally attached to, at least part of an edentulous area of (e.g., 25% . . . 50% . . . 75% . . . or 100%) a dental arch of a subject that has a plurality of scan bodies attached to dental implants, B) attached to a stackable base template that is attached to a stackable implant guide template, where the stackable base template is on, and attached to, said at least part of the edentulous area of the dental arch of said subject, or C) attached to the stackable implant guide, wherein the intraoral scan data comprises a first library of images of the calibration jig, wherein at least some of the images of the calibration jig further comprise an image of at least one of the scan bodies, and ii) 3D calibration scan data that is from a 3D scanner scanning the dental arch calibration jig, or replica thereof, wherein the 3D calibration scan data comprises a 3D dental arch calibration jig image (e.g., which is a single image with no stitches), wherein the one or more computer programs, in conjunction with the processor and database, are configured to: i) stitch together at least some of the first library of images (e.g., 50% . . . 75% . . . or 100%) of the calibration jig to generate a stitched intraoral scan 3D jig image of at least a first region of the dental arch calibration jig, wherein the stitched intraoral scan 3D jig image comprises a plurality of stitching errors; and ii) spatially align at least a portion of (e.g., 50% . . . 75% . . . or 100%) the stitched intraoral scan 3D jig image with the 3D dental arch calibration jig image to generate a calibrated dental arch image.

In some embodiments, the database further comprises digital implant planning data, wherein the digital implant planning data is configured to be used for at least one of the following: i) design said stackable base template; ii) design said stackable implant guide template, and iii) design said calibration jig, optionally including a plurality of holes therein to fit over said plurality of scan bodies attached to the dental implants. In other embodiments, wherein: a) the calibrated dental arch image comprises less than the plurality of stitching errors in the stitched intraoral scan 3D jig image, and optionally has 1.5× or 2.0× or 2.5× less stitching errors; and/or b) the calibrated dental arch image has a linear deviation from the 3D dental arch calibration jig image of less than 50 μm, or less than 45 μm, when aligned by all of the plurality of scan bodies, and optionally wherein the plurality of scan bodies comprises at least 3, 4, 5, 6, 7, or 8 scan bodies; and/or c) the calibrated dental arch image has a linear deviation from the 3D dental arch calibration jig image of less than 200 μm, or less than 150 μm, or less than 125 μm, when aligned by only two of the plurality of scan bodies.

In particular embodiments, the stitched intraoral scan 3D jig image comprises an image of at least one of the scan bodies, and optionally an image of all of the scan bodies, and optionally only one of the scan bodies. In further embodiments, the at least a first region of the dental arch calibration jig comprises all or substantially all of the dental arch calibration jig, or about 30-70% (e.g., about 30% . . . 40% . . . 50% . . . 60% or 70%) of the dental arch calibration jig. In other embodiments, the stitched intraoral scan 3D jig image aligns to about ½, ¼th, ⅙th or ⅛th of the 3D dental arch calibration jig image, which is optionally a full-arch image.

In some embodiments, the methods further comprise: d) merging the calibrated dental arch image with a second library of images of at least part of the edentulous area of the dental arch of the subject without the dental arch calibration jig in place on the subject such that a final merged image is generated, and optionally, wherein the second library comprises overlapping images of at least part of the edentulous area. In further embodiments, the methods further comprise: c) employing the final merged image to generate dentures and/or an intraoral appliance, for the subject.

In other embodiments, the one or more computer programs comprise an algorithm to achieve the spatially aligns in step c) ii), wherein the algorithm is selected from: a best-fit algorithm, an iterative Closest Point (ICP) algorithm, a Generalized ICP algorithm, a Coherent Point Drift (CPD) algorithm, a SIFT (Scale-Invariant Feature Transform) algorithm, a SURF (Specded-Up Robust Features) algorithm, a 3D Harris algorithm, a 3D SIFT algorithm, a FAST (Features from Accelerated Segment Test) algorithm, and an ORB (Oriented FAST and Rotated BRIEF) algorithm. In additional embodiments, the spatially aligns comprises realigning at least some of the first library of images of the calibration jig. In further embodiments, the first library of images of the calibration jig comprises overlapping images of the calibration jig. In some embodiments, the intraoral scan data and/or the 3D calibration scan data, comprises a file type selected from: FBX, STL, SKP, STEP, VRML, IGES, OBJ, PLY, 30xz, and DCM. In additional embodiments, the dental arch calibration jig has an outer surface bearing a non-repeating 3D pattern, and optionally wherein the non-repeating 3D pattern provides a unique reference point at areas along the dental arch calibration jig, and optionally wherein the unique reference points aid in the stitching together and/or the spatially aligns in step c).

In certain embodiments, the dental arch calibration jig comprises a plurality of holes or cut-outs that align to the plurality of scan bodies attached to dental implants. In some embodiments, the dental arch calibration jig comprises a plurality of pin holes that allow pins to be inserted therethrough to attach said dental arch calibration jig to the dental arch of the subject. In other embodiments, the plurality of dental implants comprises four dental implants, which are optionally arranged in an All-On-4 pattern, or wherein the plurality of dental implants comprise six dental implants, which are optionally arranged in an All-On-6 pattern, or optionally comprises 2-16 (e.g., 2, 3, 4, 5, 6, 7, 8, 9, 10, 11, 12, 13, 14, 15, or 16) dental implants. In further embodiments, the plurality of dental implants comprises two dental implants or is two dental implants. In additional embodiments, the methods further comprise, prior to step a), generating digital implant planning data, wherein the digital implant planning data is used for at least one of the following: i) design, and optionally fabricate, said stackable base template; ii) design, and optionally fabricate, said stackable implant guide template, and iii) design, and optionally fabricate, said calibration jig, optionally including a plurality of holes therein to fit over said plurality of scan bodies attached to said dental implants.

In some embodiments, the subject is a human. In additional embodiments, at least part of the edentulous area of the dental arch comprises all or substantially all of the dental arch, or comprises between 35-70% of the dental arch. In other embodiments, the first library of images of the calibration jig comprises at least 100, or 200-700, overlapping images of the calibration jig.

In particular embodiments, provided herein are kits and systems comprising: a) a calibration jig shaped to match the curvature of a dental arch of a subject, and having an outer surface bearing a non-repeating 3D pattern; and b) a computer memory device, wherein the computer device comprises: i) intraoral scan data that is from an intraoral scanner scanning a dental arch calibration jig: A) on, and optionally attached to, at least part of an edentulous area of a dental arch of a subject that has a plurality of scan bodies attached to dental implants, B) attached to a stackable base template that is attached to a stackable implant guide template, where the stackable base template is on, and attached to, said at least part of said edentulous area of said dental arch of said subject, or C) attached to the stackable implant guide, wherein the intraoral scan data comprises a first library of images of the calibration jig, and wherein at least some of the images of the calibration jig further comprise an image of at least one of the scan bodies, and/or ii) 3D calibration scan data that is from a 3D scanner scanning the dental arch calibration jig, or replica thereof, wherein the 3D calibration scan data comprises a 3D dental arch calibration jig image.

In certain embodiments, the dental arch calibration jig (e.g., composed of plastic) comprises at least three calibration jigs, and wherein each of the at least three calibration jigs are of a different size. In further embodiments, the dental arch calibration jig is a 3D printed dental arch calibration jig. In other embodiments, the subject is a human.

In some embodiments, provided herein are articles of manufacture comprising: a calibration jig shaped to match the curvature of a dental arch of a subject, and having an outer surface bearing a non-repeating 3D pattern. In some embodiments, the subject is a human.

In particular embodiments, provided herein are methods comprising: a) forming a plurality of holes and/or cut-outs in a dental arch calibration jig such that the holes and/or cut-outs in the dental arch calibration jig align to a plurality of dental implants attached to scan bodies that protrude from the gums of a dental arch of a subject; b) placing the dental arch calibration jig on: i) the dental arch of the subject such that the plurality of dental implants with attached scan bodies align with the plurality of holes or cut-outs, or ii) a stackable base template that is attached to a stackable implant guide template, where the stackable base template is on, and attached to, said at least part of the edentulous area of the dental arch of said subject, or iii) the stackable implant guide; and c) scanning the calibration jig on the dental arch of the subject with an intraoral scanner to generate intraoral scan data, wherein the intraoral scan data comprises a library of images of the calibration jig, and wherein at least some of the images of the calibration jig further comprise an image of at least one of the scan bodies. In further embodiments, the methods further comprise: d) sending the intraoral scan data to a service provider. In some embodiments, the method further comprises e) sending intraoral scan data of the subject's gums the service provided. In other embodiments, the methods further comprise: e) receiving dentures and/or an intraoral appliance, for the subject from the service provided generated based on the intraoral scan data. In further embodiments, wherein the dental arch calibration jig comprises a plurality of pin holes, and wherein the method further comprises inserting pins through the plurality of pin holes to attach the dental arch calibration jig to the dental arch of the subject. In other embodiments, the stackable implant guide is present and wherein the method further comprises attaching the dental calibration jig to the stackable implant guide.

In certain embodiments, provided herein are articles of manufacture comprising: a dental arch calibration jig shaped to match the curvature of a dental arch of a subject, and having an outer surface bearing a non-repeating 3D pattern. In certain embodiments, the subject is a human, and/or wherein the dental arch calibration jig comprises a plurality of pin holes that allow pins to be inserted therethrough to attach the dental arch calibration jig to the dental arch of the subject, and/or wherein the dental arch calibration jib comprises a plurality of implant holes designed to fit over a plurality of implants in the dental arch of the subject; and/or wherein the dental arch calibration is configured to attach to an implant surgical guide.

### BRIEF DESCRIPTION OF THE DRAWINGS

FIG. 1 depicts an exemplary calibration jig 100.

FIG. 2 shows a step of obtaining a highly accurate digital 3D calibration scan 140 of the calibration jig 100 using a desktop scanner 120, stored in an STL file. In certain embodiments, this image is stick-free and/or is a single image.

FIG. 3 shows a pictorial representation of an exemplary 3D calibration scan 140 of a calibration jig 100.

FIG. 4 shows a study model representing a dental arch 200 of a patient, with multiple dental implants 220, each dental implant 220 having a scan body 240 mounted on it. In general, a scan body in the dental industry is a small device used in digital dentistry to capture accurate position of dental implants in patient's mouth. They are typically made of biocompatible materials such as titanium or Polyether ether ketone. These bodies generally have specific designs that correspond to different types of dental implants. Scan bodies, in some embodiments, are seated and secured into the dental implant before scanning (e.g., with an intraoral scanner). Examples of commercial scan bodies include, but are not limited to, DESS scan bodies and Elos Accurate® Scan Bodies.

FIG. 5 shows a dental arch 200 with a calibration jig 100 positioned on the dental arch 200 with exemplary dental implants 220 and exemplary scan bodies 240.

FIG. 6 shows an exemplary Intra-oral scanner (IOS) scan 270 of a dental arch 200 with a calibration jig 100 positioned on a dental arch 200 and dental implants 220 and scan bodies 240.

FIG. 7 shows how an exemplary IOS scan 270 is, in some embodiments, divided into multiple scan segments 301, 302, 303, 304, 305, and 306 to form a segmented scan 300 before the calibration step.

FIG. 8 shows a step of using a 3D calibration scan 140 as a reference and calibrating the position of the multiple segments 301, 302, 303, 304, 305, and 306 of an IOS scan 270 against the 3D calibration scan 140.

FIG. 9 shows an exemplary calibrator intraoral scan digital model 500 prepared using the calibration step of FIG. 8.

FIG. 10 shows the overall design of the exemplary study in Example 1 that compares the accuracy of a calibrated intraoral scan according to three other methods.

FIG. 11 shows an exemplary workflow from Example 1 for a calibrated intraoral scan.

FIG. 12 shows methods from Example 1 of data alignment (A) and (B) and linear deviation measurements (C).

FIG. 13 shows a table of measurements from Example 1 of trueness and precision of 3D deviation (μm) between baseline and different groups (aligned by all scan bodies). Note: a, b, c, different superscript letters within the same column denote statistically significant differences (p<0.05). Abbreviations: CISP, calibrated intraoral scan protocol; CONV, conventional impression group; IOS, intraoral scan group; IOS-SA, intraoral scan with scan aid group; Min, minimum; Max, maximum; SD, standard deviation.

FIG. 14 shows a table of measurements from Example 1 of trueness and precision of 3D deviation (μm) of each scan body between baseline and different groups (aligned by first and second scan bodies). Note: a, b, c, different superscript letters within the same column denote statistically significant differences (p<0.05). Abbreviations: CISP, calibrated intraoral scan protocol; CONV, conventional impression group; IOS, intraoral scan group; IOS-SA, intraoral scan with scan aid group; Min, minimum; Max, maximum; SD, standard deviation.

FIG. 15 shows a comparison from Example 1 of trueness (A) and precision (B) of different groups (aligned by all scan bodies).

FIG. 16 shows comparison from Example 1 of trueness and precision of different groups (aligned by scan bodies one and two).

FIG. 17 shows how (A) Stitching errors are accumulated in long-span intraoral scans and (B) how, in the calibrated intraoral scan in Example 1, a desktop scan of the calibration jig was used to correct the stitching in the full-arch implant intraoral scan.

FIG. 18 shows an exemplary workflow from Example 2 for a calibrated intraoral scan.

FIG. 19 shows the overall design of the exemplary study in Example 2 that compares the accuracy of a calibrated intraoral scan to two other methods.

FIG. 20 shows a table of measurements from Example 2 comparing trueness and precision between a calibrated intraoral scan to two other methods.

FIG. 21 shows three exemplary shapes for a calibration jig, each of which generally have cut-outs that fit around scan bodies.

FIG. 22 shows an exemplary flow chart of calibrated implant intraoral scan protocol.

FIG. 23 shows an exemplary workflow that includes initial digital planning, which can be used to design the implant guide templates and calibration jigs.

FIG. 24 an exemplary flow chart of a calibrated implant intraoral scan protocol, that includes an initial digital planning, which can be used to design the implant guide templates and calibration jigs.

FIG. 25A shows an exemplary implant guide template (650), with a plurality of pin holes (600) (to receive pins used to secure the implant guide to a patient's dental arch), and a plurality of implant guide openings (655). FIG. 25B shows an exemplary calibration jig (100), with a plurality of plurality of pin holes (600) (to receive pins used to secure the implant guide to a patient's dental arch), and a plurality of top openings (605) that align with the implants in a patient's jaw.

FIGS. 26A and 26B shows stackable guides (700) that is mounted on alveolar bone (705). The stackable guides include a stackable base template (710) and an implant guide template (650), as well as a provisional dental prosthesis (715), which may instead be the final denture. FIG. 26B further includes an exemplary calibration jig (100), which can connect to one or more other components in the stackable implant guide.

### DETAILED DESCRIPTION OF THE INVENTION

Provided herein are articles, systems, kits, and methods for generating calibrated dental arch images by processing intraoral scanning images and a dental arch calibration jig image (e.g., generated as a single image without stitches). In certain embodiments, a library of intraoral scanning images are generated by scanning a dental arch calibration jig in a subject's mouth. In particular embodiments, at least some of the first library of images of the calibration jig are stitched together to generate a stitched intraoral scan 3D jig image, at least a portion of which is spatially aligned to at least a portion of said 3D dental arch calibration jig image to generate a calibrated dental arch image.

Intraoral scanners (IOS) have been increasingly used in dental clinics for impressions of inlays, crowns, bridges, single implant crowns, and short-span implant bridges. However, IOS has insufficient accuracy for full-arch implant impressions. Instead of IOS, dentists rely on conventional impression approaches, or using a Photogrammetry deceive to make impressions for full-arch implant impressions. The conventional impression approach is time-consuming and buying an additional Photogrammetry device can be costly. In certain embodiments, the methods herein use a calibration jig, and an associated high-resolution 3D calibration scan of that calibration jig, to realign acquired IOS images and correct for spatial inaccuracy in the IOS image introduced during the scanning process.

Exemplary Embodiments with Reference to the Figures

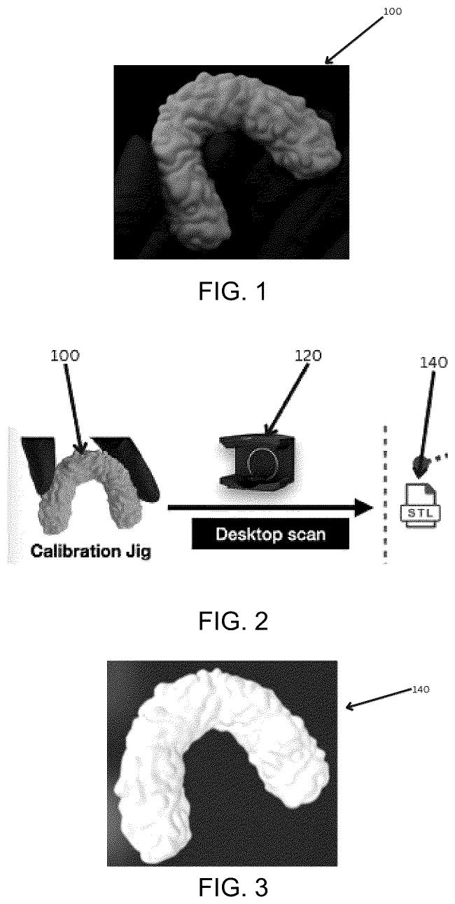

FIG. 1 depicts a calibration jig 100 used in certain methods herein. The calibration jig 100 could be designed using 3D modeling software (e.g. version 2.83; The Blender Foundation, Amsterdam, the Netherlands). The calibration jig 100 is preferably shaped to match the curvature of an edentulous dental arch 200, with the outer surface featuring a unique, non-repeating 3D pattern 105 intended to facilitate scanning by an IOS 280. The calibration jig 100 may be fabricated using a 3D printer (e.g. P30 printer, Straumann AG, Basel, Switzerland) and model resin (e.g. ModelX, Pro Resins, Straumann AG, Basel, Switzerland) and post-processed (e.g. by washing and light curing).

FIG. 2 shows a step of obtaining a highly accurate digital 3D calibration scan 140 of the calibration jig 100. After fabrication, the calibration jig 100 may be sprayed with scanning powder (RMH3 Dental 3D Scanning Spray, Chantilly, VA) and may be scanned using a high resolution desktop scanner 120 (e.g. LS3; Kavo, Biberach, Germany) to produce a highly accurate 3D calibration scan 140, for example in an STL file or other data file. FIG. 3 shows a pictorial representation of a highly accurate digital 3D calibration scan 140 of a calibration jig 100.

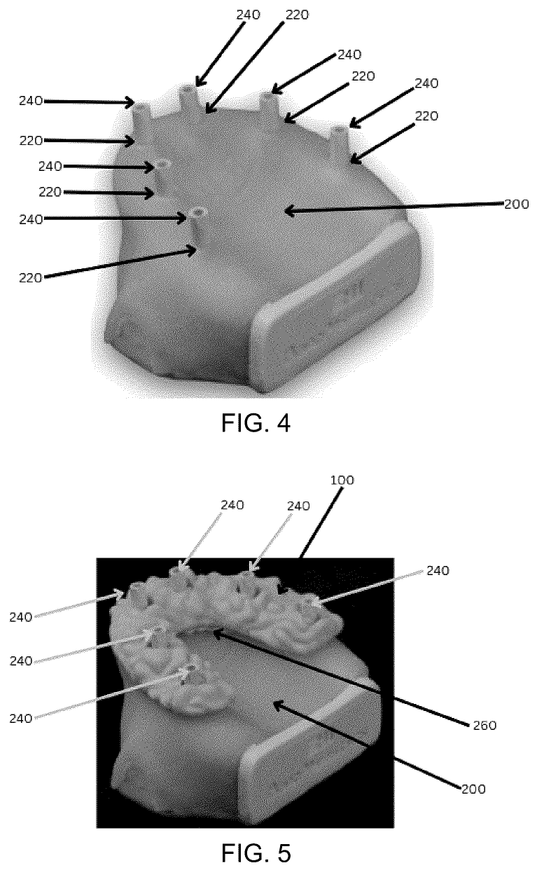

FIG. 4 shows a study model (e.g. from BoneModels S.L.U., Castellon, Spain) representing the dental arch 200 of a patient, with multiple dental implants 220 (e.g. 4.5×12 mm, BLX, Institute Straumann AG, Basel, Switzerland) marked with multiple scan bodies 240 for use with an IOS 280. FIG. 5 shows a calibration jig 100 placed on the dental arch 200 for use in methods herein. This may be accomplished, for example, by creating holes in the jig 100 (e.g., using a drill or other tool) in the locations of the multiple implants 220 and scan bodies 240, for example using a straight handpiece with acrylic burs, so the calibration jig 100 can be positioned on the dental arch 200, for example using bite-registration PVS material 260, without interfering with the implants 220 and scan bodies 240 that extend from the dental arch 200.

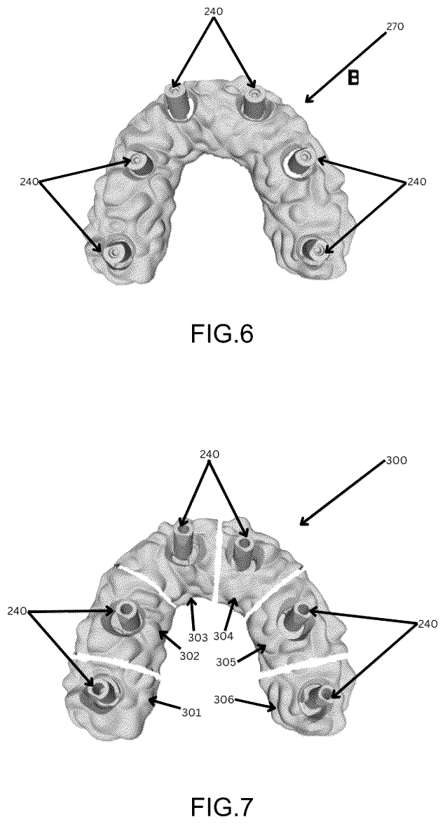

FIG. 6 shows an IOS scan 270 of the dental arch 200 (with implants 220 and scan bodies 240) together with the calibration jig 100. An IOS scan 270 can be obtained using any suitable IOS 280 (e.g. Trios3, 3Shape A/S, Copenhagen, Denmark). The IOS scan 270 is preferably inspected to ensure the dental arch 200 and scan bodies 240 are captured properly without noticeable defects, before being exported, for example as an STL file or other data file.

FIG. 7 shows how an IOS scan 270, in certain embodiments, is divided into multiple segments (e.g., 301, 302, 303, 304, 305, and 306) before calibration. An IOS scan 270 can be divided, for example, using dental computer-aided design (CAD) software (e.g. Exocad GmbH, Darmstadt, Germany) into multiple segments, each containing a dental implant 220 and scan body 240 and a corresponding segment of the calibration jig 100. The IOS scan 270 of FIG. 6 is divided into a segmented scan 300 having 6 segments 301, 302, 303, 304, 305, and 306 corresponding to 6 dental implants 220 and scan bodies 240 on the dental arch 200. However this is not required and more or less segments could be used (e.g., depending on how many dental implants are present).

An IOS scan 270 is preferably initially processed to remove the scan bodies 240 (crop each scan body 240 at its base) while keeping the remaining scan region unaltered, to increase the accuracy of superimposition between the reference 3D calibration scan 140 and the multiple segments 301, 302, 303, 304, 305, and 306.

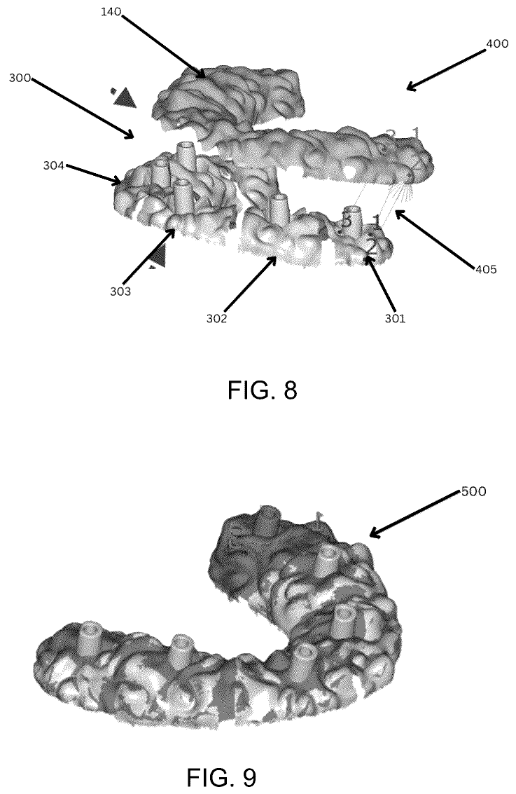

FIG. 8 shows a step of using a 3D calibration scan 140 as a reference and aligning the position of the multiple scan segments (e.g., 301, 302, 303, 304, 305, and 306) of a segmented scan 300 against that reference. This can be accomplished, for example, by superimposing each scan segment 301, 302, 303, 304, 305, and 306 onto the 3D calibration scan 140 using software (e.g., Exocad GmbH, Darmstadt, Germany). The spatial alignment of each scan segment (e.g., 301, 302, 303, 304, 305, and 306) to the 3D calibration scan 140 may include, for example, a three-point alignment 405 using a best-fit algorithm (or similar algorithm) for each scan segment to the 3D calibration scan 140 at the locations of the scan bodies. Once each of the scan segments 301, 302, 303, 304, 305, and 306 is spatially realigned and superimposed onto the 3D calibration scan 140, the multiple realigned segments 301, 302, 303, 304, 305, and 306 can be merged back together into a single calibrated intraoral scan digital model 500, for example in an data file (e.g., STL file), as shown in FIG. 9.

As IOS sensors have a concomitantly small range, a series of scans are overlapped to reproduce large spans, such as for complete partial or complete arches. Minor errors are introduced at each junction between scans, resulting in so-called “stitching error” which can be especially pronounced in long-span intraoral scans. Because a high resolution desktop scanner is used to prepare the 3D calibration scan of the calibration jig, that 3D calibration scan is free from stitching errors. By realigning the stitched-together IOS scan of a jig onto the stitch-free 3D calibration scan of the same jig, a calibrated intraoral scan can be prepared with the stitching errors removed according the methods herein.

In certain embodiments, the calibrated intraoral scans generated herein may be seamlessly integrated into clinical practice without burdening the dentist. For example, a third party may pre-fabricate and scan the calibration jig with a scanner (e.g., high-accuracy scanner), and offer a calibration jig and digital 3D calibration scan file as a package. Additionally, the calibration jig can be pre-fabricated and mass-produced in (for example) small, medium, and large sizes, each with its own 3D calibration scan, ensuring a suitable fit for various patients' mouth sizes. In some embodiments, the calibration jigs are pre-stocked at the dental office (e.g., with their corresponding 3D calibration scans).

In particular embodiments, when a patient requiring an implant impression arrives (e.g., full or partial arch implant, such as a patient missing some or all of their teeth), the dentist selects a jig of the appropriate size, and customizes it by drilling holes (e.g., to fit over dental implants), enabling a passive fit around the dental implants (and attached scan bodies). Subsequently, an intraoral scan of the dental arch, implants, scan bodies, and jig is performed. In certain embodiments, upon completing the scan, both the intraoral scan and the 3D calibration scan of the jig are forwarded to a laboratory or employed in the dental office itself. The data from the 3D scan of the jig is then as a calibrator to align the images from the intraoral scanner.

In certain embodiments, an advantage of the methods herein includes streamlining the process for dentists by solely requiring an intraoral scan (IOS), and eliminating the necessity for additional devices such as a photogrammetry scanner. In particular embodiments, the methods herein provides accuracy comparable to, or even better than, conventional open-tray and splinting impression techniques. In some embodiments, the calibration jig is prefabricated and scanned, which eliminates the additional appointment for preliminary cast and allows for efficient transmission of all data digitally. In particular embodiments, post-processing procedures, including segmentation, alignment, and model creation, are completed around 5 minutes (e.g., by a technician who is experienced in CAD software).

In some embodiments, a digital implant plan will be made using, for example, a patient's CT scan, denture scan, or intraoral scan. Digital implant plans are known in the art and are described, for example, in Schubert et al., British Dental Journal volume 226, pages 101-108 (2019), herein incorporated by reference. In particular embodiments, the 3D positions of implants are designed in this plan. In additional embodiments, during the digital surgery planning stage, the digital planning does not only generate an implant guide template, but also generates calibration jig herein, which has, for example, holes opened based on planned implant positions in the subject's dental arch. The calibration jig can be secured in patient's mouth by fixation pins or be attached to an implant guide template. This calibration jig can also be scanned by a 3D scanner before being delivered to dentist.

During the guided implant placement, once the implants are placed, scan bodies can be immediately attached to the implants/multi-unit-abutment. Following, the calibration jig is attached, and an intraoral scan is performed (e.g., generating a library of images). This intraoral scan is processed with the methods and systems herein become the definitive scan for, for example, a full-arch implant restoration. Such methods and systems, for example, make it possible to get accuracy full-arch implant scan without using a photogrammetry device.

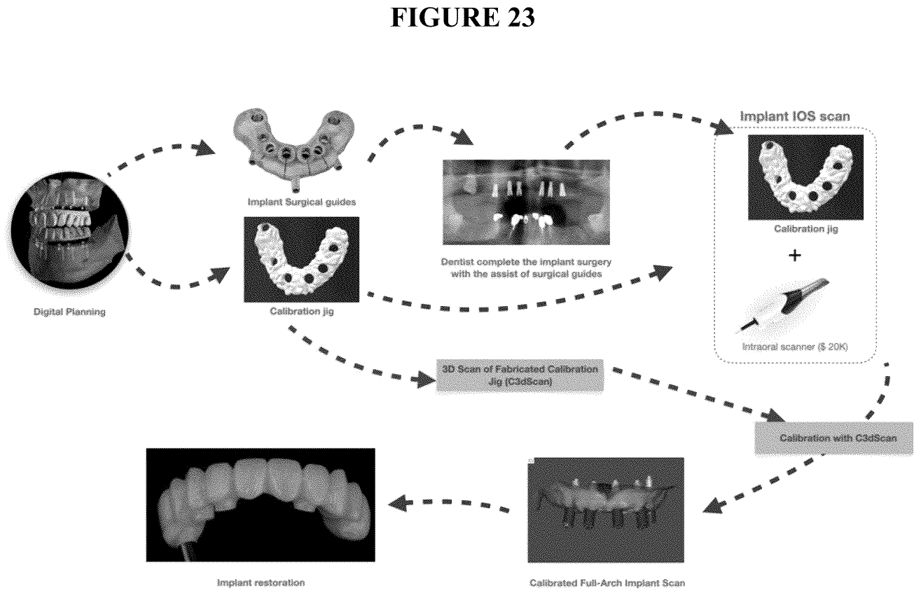

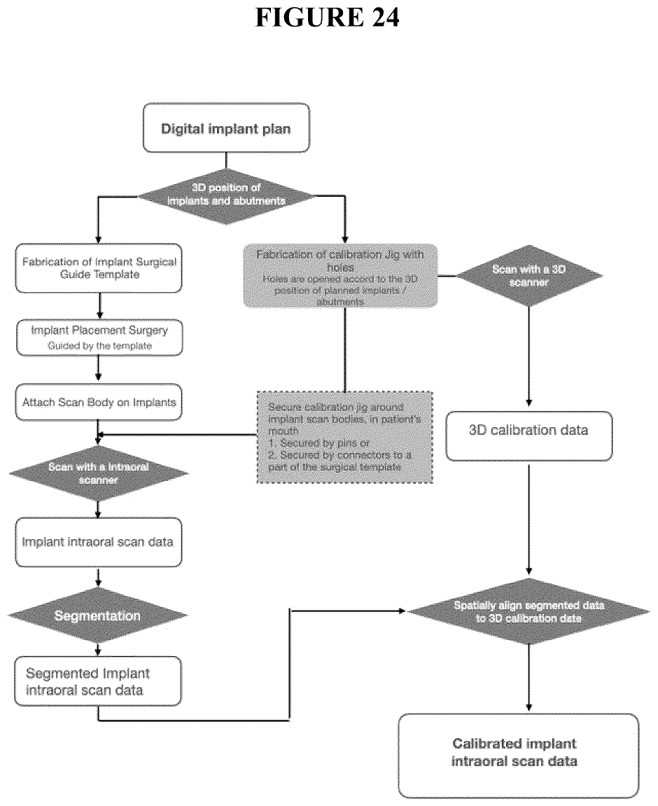

Exemplary overall workflows, where digital planning is used, are shown in FIGS. 23 and 24. FIG. 23 shows an exemplary work flow that includes initial digital planning, which can be used to design the implant guide templates and calibration jigs. FIG. 24 shows an exemplary flow chart of a calibrated implant intraoral scan protocol, that includes an initial digital planning, which can be used to design the implant guide templates and calibration jigs. This workflow starts with digital implant planning. A digital implant plan is made using, for example, a patient's CT scan, denture scan, intraoral scan, etc. 3D positions of implant guide template implants are designed in this plan, which is a known existing workflow and has been routinely used in dental implant treatment (see Schubert et al., British Dental Journal volume 226, pages 101-108 (2019)).

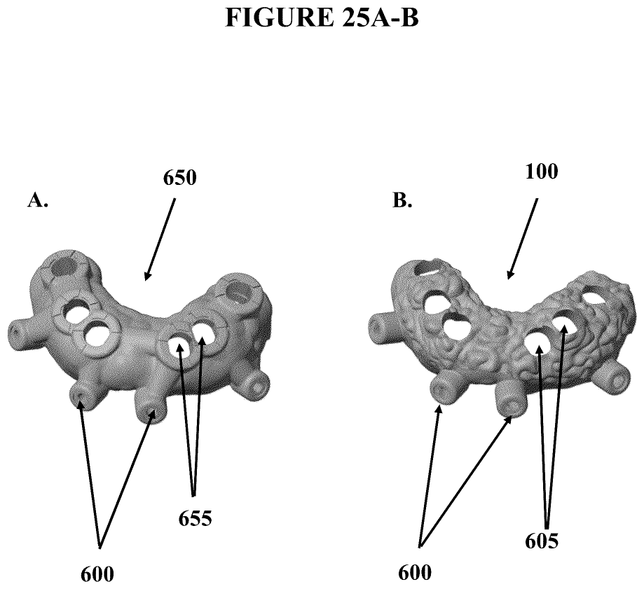

Next, implant guide templates are designed according to the digital implant plan and fabricated. The implant guide templates can be fixed in a patient's mouth by pins (through in holes), helping doctor place implants at the planned position. FIG. 25A shows an exemplary implant guide template (650), with a plurality of pin holes (600) (to receive pins used to secure the implant guide to a patient's dental arch), and a plurality of implant guide openings (655).

Next a calibration jig herein is designed and fabricated according to the digital implant plan. Holes are made in the calibration jib according to the planned implant position. FIG. 25B shows an exemplary calibration jig (100), with a plurality of plurality of pin holes (600) (to receive pins used to secure the implant guide to a patient's dental arch), and a plurality of top openings (605) that align with the implants in a patient's jaw.

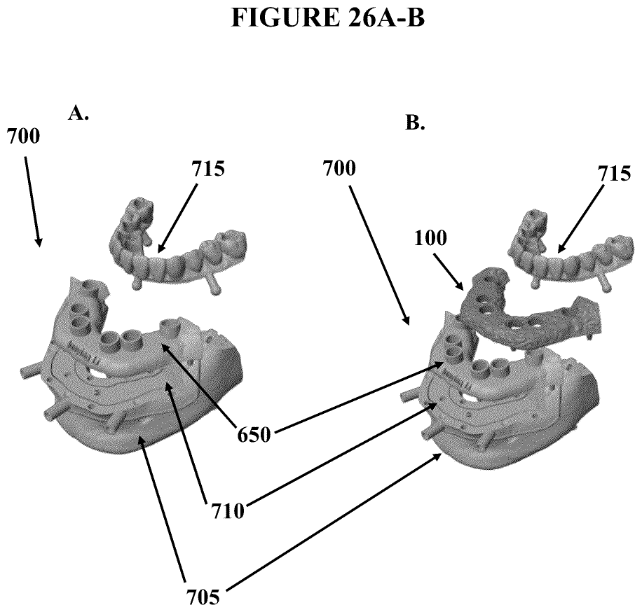

In certain embodiments, a stackable surgical guide is employed in the methods and systems and devices herein. The base template of a stackable surgical guide is an initial step in a guided implant procedure and is used to precisely position the guide on the alveolar bone. The base is connected to the bone with retainer pins, and then other removable guides are attached to the base to perform the remaining steps of the procedure. FIGS. 26A and 26B shows stackable guide (700) that is mounted on alveolar bone (705). The stackable implant guides include a stackable base template (710) and an implant guide template (650), as well as a provisional dental prosthesis (715), which may instead be the final denture. FIG. 26B further includes an exemplary calibration jig (100), which can connect to one or more other components in the stackable implant guide.

### EXAMPLES

### Example 1

### Generating Calibrated Intraoral Scans

Example 1 describes a study that compares the accuracy of an exemplary calibrated intraoral scan protocol (CISP) according to one embodiment herein to three other methods: (1) intraoral scan (IOS), (2) intraoral scan with scan aid (IOS-SA), and (3) conventional splinted open-tray impression (CONV).

As discussed in more detail below, in the study of Example 1, the exemplary CISP method demonstrated comparable accuracy to the clinical standard, the conventional splinted open-tray impression. The exemplary CISP method also excelled in a virtual passive fitting test.

In the study of Example 1, the exemplary CISP method, and the three other methods, were applied to the same maxillary edentulous model with 6 dental implants. Each of the four methods was repeated 10 times, and a direct scan of the model with a desktop scanner was used as a reference model. The alignment of scans and the reference model was conducted by two methods: (a) aligning all scan bodies to evaluate the overall fit, and (b) aligning the first and second scan bodies to simulate the Sheffield fit test for passive fitting of multiple implant-supported prostheses. Linear deviations from the reference model (trueness) and within each group (precision) were analyzed using Python scripts.

In the study of Example 1, when aligned by all scan bodies, the CISP group exhibited comparable mean trueness (38.33 μm) and precision (45.97 μm) to the CONV group (44.30 and 47.92 μm respectively). Both CISP and CONV groups significantly outperformed the IOS group (86.82 and 83.17 μm, respectively). Furthermore, in the virtual Sheffield fit test, the CISP group achieved the highest levels of mean trueness at the end span (121.7 μm), making a linear deviation reduction of 36.7%, 60%, and 41.4% when compared to the CONV, the IOS, and the IOS-SA groups, respectively. Moreover, the CISP group (104.3 μm) displayed a remarkable 65, 182, and 86 μm advantage in precision over the CONV, IOS, and IOS-SA groups, respectively.

### Study Design

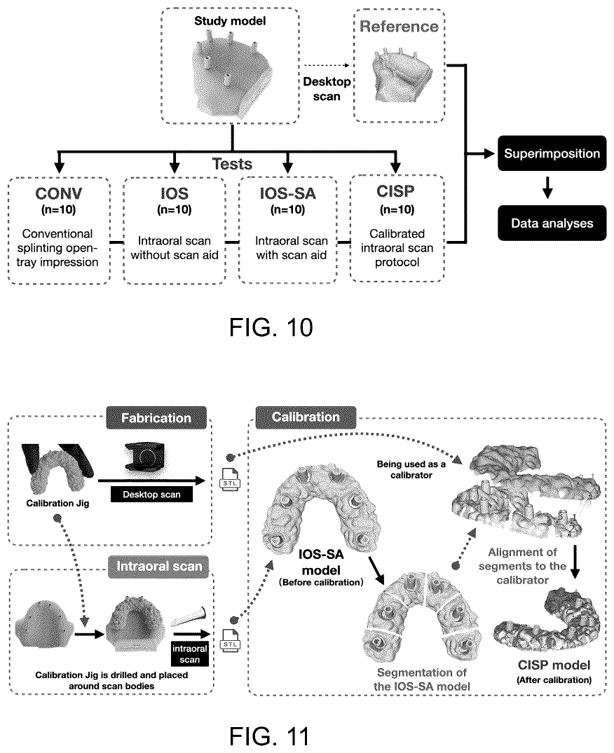

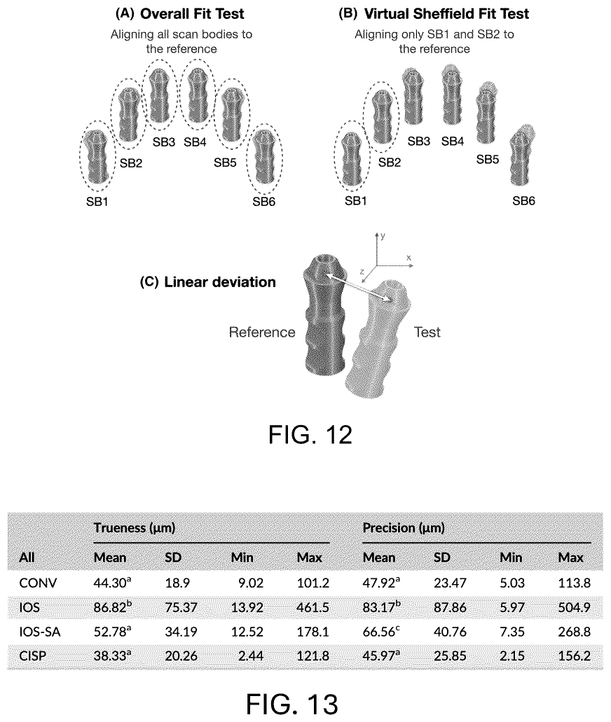

The overall workflow of the study in Example 1 is illustrated in FIG. 10. In the study, a maxillary edentulous model (BoneModels S.L.U., Castellon, Spain) was used. Six dummy implants (4.5 12 mm, BLX, Institute Straumann AG, Basel, Switzerland) were evenly placed in the model to mimic the All-on-6 scenario, each of them numbered from 1 to 6. All implants achieved a primary stability of more than 50 N/cm. Subsequently, six multi-unit abutments (Screw-retained abutment, Institute Straumann AG, Basel, Switzerland) were placed and torqued to 35 N/cm.

Four groups of impression approaches were made from the same model, with all impressions taken at the abutment level: (1) intraoral scan only (IOS), (2) intraoral scan with scan aid (IOS-SA), (3) CISP, (4) and the conventional impression method (CONV). Each approach was repeated 10 times, generating scan data for a total of 240 implant sites.

Additionally, a direct scan of the model using a desktop scanner (LS3; Kavo, Biberach, Germany) served as the reference model for accuracy evaluation. Accuracy was assessed through both trueness and precision, according to ISO standards. “Trueness” means the measurements against true values or a gold standard, indicated here by the deviation between the reference model's direct desk scan and each test group's scans. “Precision” reflects the consistency of repeated measurements within the same group.

### Exemplary Calibrated Intraoral Scan Protocol

FIG. 11 shows an exemplary workflow from Example 1 for a calibrated intraoral scan protocol according to one aspect of our invention. First, a calibration jig is fabricated and scanned with a desktop scanner to generate a 3D calibration model (3D calibration scan). Second, the calibration jig is scanned together with scan bodies (“SBs”), which are attached to the dental implant posts, marking the positions of dental implants in a full-arch implant intraoral scan. Finally, the full-arch implant intraoral scan is calibrated by segmentation and alignment to the 3d calibration model.

### Fabrication of Calibration Jig

In the study of Example 1, a calibration jig was designed using 3D modeling software (version 2.83; The Blender Foundation, Amsterdam, the Netherlands). It is shaped to match the curvature of an edentulous dental arch, with the outer surface featuring a unique, non-repeating 3D pattern intended to enhance scannability by an IOS. The calibration jig was fabricated using a 3D printer (P30 printer, Straumann AG, Basel, Switzerland) and model resin (ModelX, Pro Resins, Straumann AG, Basel, Switzerland) and post-processed (washing and light curing). After fabrication, the jig was sprayed with scanning powder (RMH3 Dental 3D Scanning Spray, Chantilly, VA) and was scanned using a desktop scanner (LS3; Kavo, Biberach, Germany) to produce an STL file, which serves as a 3D calibrator within the CISP group (FIG. 2).

### Impression Procedures

In the study of Example 1, for the IOS and IOS-SA groups, the intraoral SBs were hand-tightened (to the dental implant posts) according to the manufacturer's recommendation and were not removed during repeated scans. Scanning consistently followed the recommended manufacturer's scan path under the same ambient light source, starting at SB1 along the occlusal surfaces of the full arch, proceeding to the palatal surfaces, and concluding with the buccal surfaces. The description of how an impression was made in each group is as follows.

For the IOS group, following the placement of intraoral SBs, the model was scanned using an IOS (Trios3, 3Shape A/S, Copenhagen, Denmark). Scans were inspected to ensure the model and SBs were captured properly without noticeable defects. Scans were exported as STL files.

For the IOS-SA group, the 3D-printed calibration jig, which served as a scan aid, was fitted onto the model, and six holes were created using a straight handpiece with acrylic burs to ensure a passive sitting of the jig around the SBs. Following this, the calibration jig was firmly attached to the model using bite-registration PVS material to prevent any movement. The model with calibration jig was subsequently scanned with an IOS, generating an STL file of the scan.

For the CISP group, the scans from the IOS-SA group were further calibrated to generate the CISP scans (FIG. 2). This calibration was performed using dental computer-aided design (CAD) software (Exocad GmbH, Darmstadt, Germany). Initially, the 3D scan from the IOS-SA group was divided into six segments, each containing an implant scan body and the corresponding calibration jig segment. These six segments were individually aligned with the 3D calibrator using the best-fit algorithm. Subsequently, the aligned segments were merged into a single STL file.

For the CONV group, ten open-tray impressions and master casts were made from the study model using the reported technique in Reference [25]. Open tray impression copings were secured on the implant abutment and then splinted together with dental floss and pattern resin. The splinted framework was sectioned between each implant and bonded with a small amount of the same resin to prevent tension from resin shrinkage. Impressions were made using PVS materials, and the master cast was poured with type IV dental stone. SBs were hand-torqued onto the master casts, and scans were made using a desktop scanner (LS3; Kavo, Biberach, Germany).

### Data Superimposing and Accuracy Measurements

In the study of Example 1, all scans from all four methods (IOS, IOS-SA, CISP, CONV) were superimposed onto the reference model using software (Exocad GmbH, Darmstadt, Germany) employing two methods: (1) The first method was to align all SBs together to test the overall fitting of the scan; (2) The second method was to align only the two end unit SBs (SB 1 and 2) to simulate the 1-screw or Sheffield fit test for passive fitting of multiple implant-supported prostheses.

In both approaches, each SB was initially cropped at its base while keeping the relevant scan region unaltered, thereby removing redundant surface information to increase the accuracy of superimposition. The spatial alignment of each pair of test and reference scans included a three-point alignment of scans, followed by a best-fit algorithm of all intraoral scan body surfaces or SB1 and 2 surfaces (FIG. 11). Once superimposed, all scan data were imported into a 3D software (version 2.83; The Blender Foundation, Amsterdam, Netherlands) for measurements with Python scripts. Deviation was measured at the center of the abutment platform. Trueness was defined as the 3D deviation between the test group and the reference, while precision was quantified as the 3D deviation within each group, indicating the repeatability of each impression approach.

### Statistics Analysis

In the study of Example 1, the sample size calculation was performed using G*Power 3 software. While the present disclosure is not limited to any particular mechanism, and an understanding of the mechanisms in not necessary to practice the disclosure, the investigators hypothesize that using a calibrated scan aid improves accuracy compared to the impression for full arch implants. A sample size of 10 was considered enough based on a priori power analysis (α=0.05, power—0.8). For the data description, mean, standard deviation, maximum, and minimum were presented. All the statistical analysis was performed with GraphPad Prism software (version 10.0, GraphPad Software Inc. FL) and R Studio (version 2021.09.0, RStudio). Data normality was checked by the Kolmogorov-Smirnov test. The mean accuracy (trueness and precision) of different approaches was compared using a linear mixed model, taking repeated structure measures into account. All reported p-values were two-sided, and the significance level was set at α=0.05.

### Results

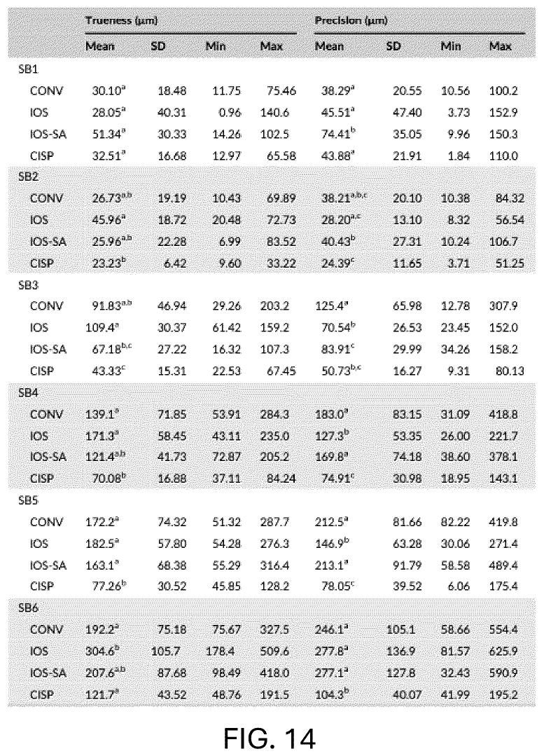

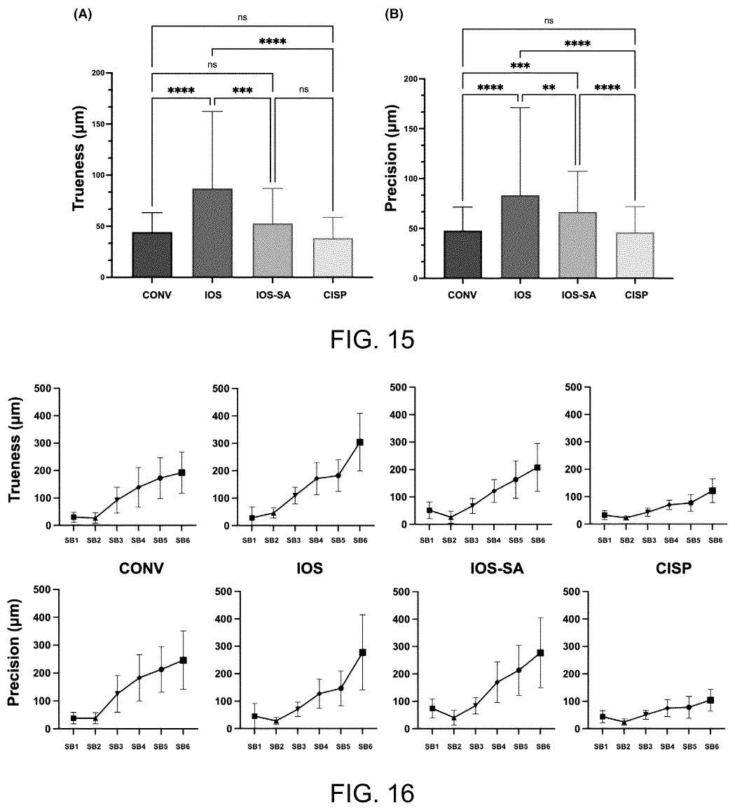

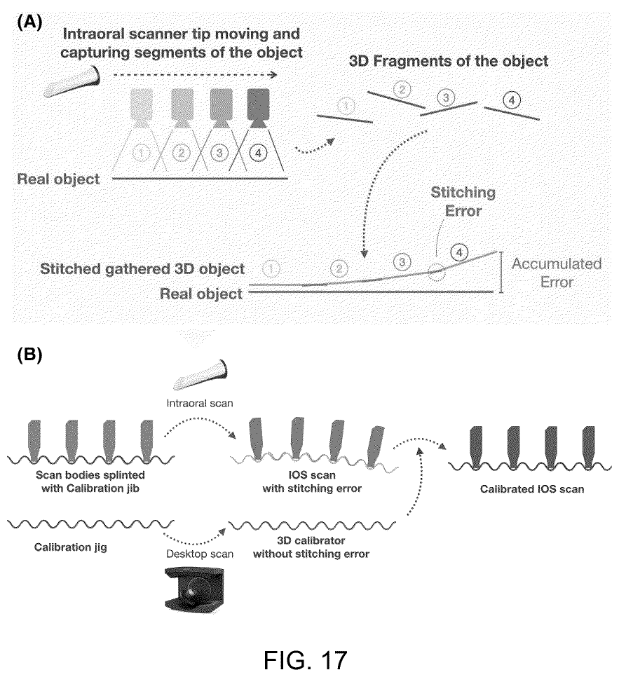

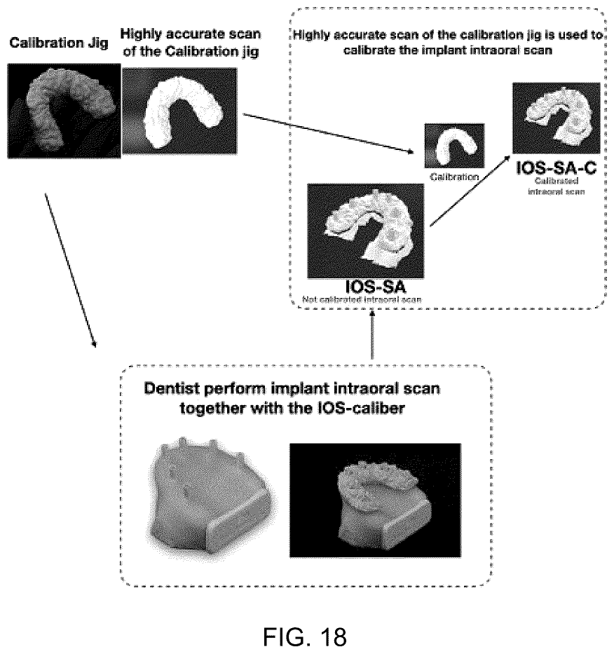

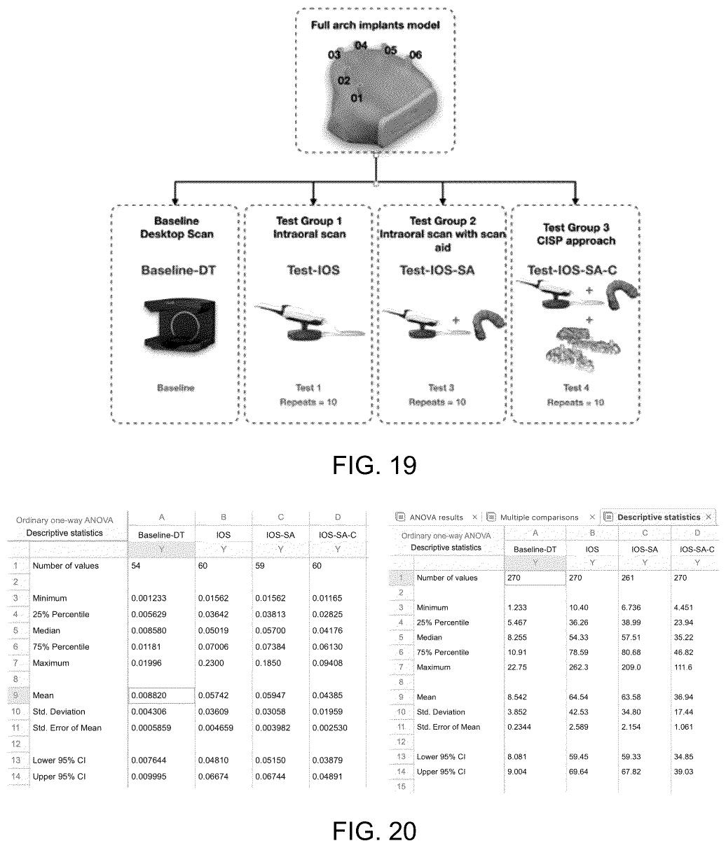

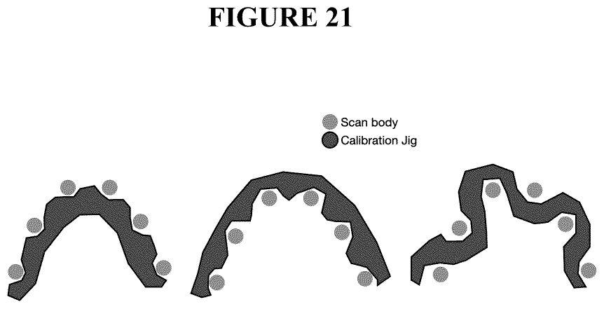

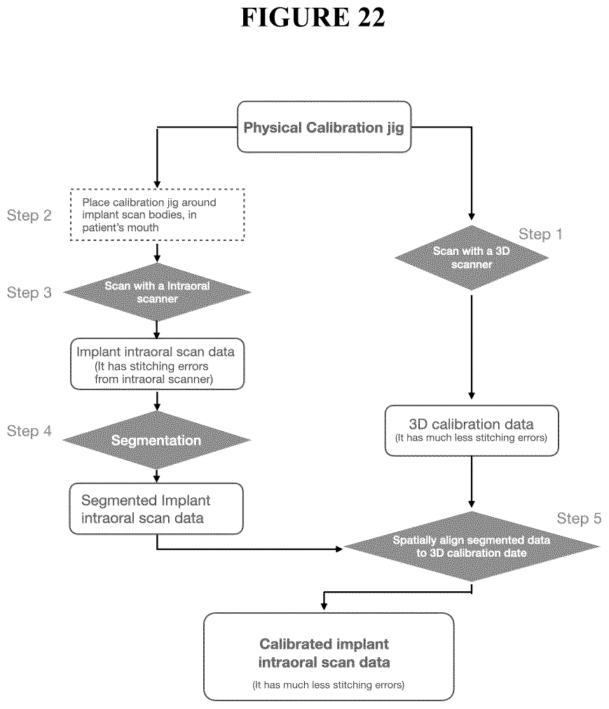

In the study of Example 1, a total of 40 scans, using 2 alignment methods, comprising 480 implant positions, were analyzed. The results for the four impression approaches, considering trueness and precision (aligned by all SBs), are presented in FIG. 13. FIG. 14 shows results for trueness and precision of 3D deviation (μm) of each scan body between baseline and the four impression groups (when aligned by first and second scan bodies).

With respect to trueness, differences in linear deviation between the reference model and all groups, when aligned by all SBs, are depicted in FIG. 15(A). The CONV group exhibited a mean deviation of 44.3 μm, ranging from 9.02 to 101.2 μm. In contrast, the IOS group showed a mean deviation of 86.82 μm, ranging from 13.92 to 461.5 μm, which is significantly greater than the IOS-SA (mean: 52.78 μm, range: 12.52-178.1 μm; p=0.0002) and CISP (mean: 38.33 μm, range: 2.44-121.8 μm; p<0.0001). While the CISP group displayed the lowest mean deviation among all groups, it failed to show a significant difference when compared to the CONV group (p=0.8766) and the IOS-SA group (p=0.2691). When aligned by the SB1 and SB2, all groups showed a decrease in trueness over the length of the complete arch (FIG. 16). Starting from SB3, the CISP group showed the highest trueness compared to the other groups (FIG. 14). CISP exhibited a trueness advantage of 50-90 μm over the CONV group. At SB6, the CISP group demonstrated superior accuracy, with a trueness level of 121.7 μm, in comparison to the CONV group (192.2 μm), the IOS group (304.6 μm), and the IOS-SA group (207.6 μm). This corresponds to reductions in deviation of 36.7%, 60%, and 41.4%, respectively.

With respect to precision, precision comparisons for all four groups, when aligned by all SBs, are presented in FIG. 15(B). Among the groups, the CISP group (mean: 45.97 μm, range: 2.15-156.2 μm) and the CONV group (mean: 47.92 μm, range: 5.03-113.8 μm) exhibited similar and the highest precision. The IOS group showed the lowest precision, with a mean value of 83.17 μm and a range of 5.97 to 504.9 μm, followed by the IOS-SA group (mean: 66.56 μm, range: 7.35-268.8 μm). When aligned using SB1 and SB2 (and not all SBs), there was a decline in precision across the entire arch length for all groups (see FIG. 16). Starting from SB3, the CISP group demonstrated superior precision when compared to the remaining groups, as indicated in FIG. 14. At SB6, the CISP group (104.3 μm) displayed a remarkable 65 μm, 182 μm, and 86 μm advantage in precision over the CONV, IOS, and IOS-SA groups, respectively.

The findings of the study of Example 1 indicate that the exemplary CISP method produces significantly more accurate results than either IOS alone or IOS-SA. When measured against the CONV method, the established clinical benchmark of open-tray impressions with a splinting framework, CISP demonstrated comparable accuracy in overall fit test and superior accuracy in virtual Sheffield (1-screw) fit test.

The CISP group demonstrated significantly improved accuracy (Trueness: 38.33 μm; Precision: 45.97 μm) compared to the IOS-SA group. Additionally, the CISP's accuracy was comparable to that of conventional impressions (Trueness: 44.30 μm; Precision: 47.92 μm) and showed superior performance in the virtual Sheffield fit test (Table 2 and FIG. 5). The range for a clinically acceptable fit of an implant-supported fixed prosthesis falls between 10 and 150 μm. 27-29. In the Sheffield fit test, the trueness of all SBs from the CISP group falls into this range, while the IOS, IOS-SA, and CONV groups seem to exceed this range, at least in SB 6.

### Example 2

Comparison of Accuracy of Full-Arch Implant Impressions Made with a Calibrated Intraoral Scan Protocol (CISP) Compared to Prior Art IOS, and IOS-SA

This Example 2 describes a study that compares the accuracy of an exemplary calibrated intraoral scan protocol (CISP) according to one aspect of the invention to other methods: (1) intraoral scan (IOS) and (2) intraoral scan with scan aid (IOS-SA).

### Results

In the study of Example 2, trueness was measured as 3D deviation between a test group and the baseline, and precision was measured as 3D deviation within a test group. A linear mixed model was used to determine significant differences.

As shown in FIG. 20 (left side) the average trueness was 57.42±36.09 μm in IOS, 59.47±30.58 μm in IOS-SA group, and 43.85±19.59 μm in the IOS-SA-C(CISP) group. As shown in FIG. 20 (right side) the average precision was 64.54±42.53 μm in IOS group, 63.58±34.80 μm in IOS-SA group, and 36.94±17.44 μm in the IOS-SA-C(CISP) group.

In the study of Example 2, our statistical analysis showed the CISP approach used for the IOS-SA-C group provided significantly better trueness and precision than either the IOS or the IOS-SA group. No significant difference in trueness or precision was found between the IOS and IOS-SA groups.

In conclusion, the study of Example 2 showed that, the presented calibrated intraoral scan protocol (CISP) significantly improves accuracy of full-arch implant impressions. The use of a scan aid, e.g. in the IOS-SA group, did not result in improved accuracy of a full-arch implant intraoral scan compared to IOS alone without the scan aid.

### REFERENCES

1. Li et al., Calibrated intraoral scan protocol (CISP) for full-arch implant impressions: An in vitro comparison to conventional impression, intraoral scan, and intraoral scan with scan-aid. Clin Implant Dent Relat Res. 2024; 1-10.
2. Siqueira et al. Intraoral scanning reduces procedure time and improves patient comfort in fixed prosthodontics and implant dentistry: a systematic review. Clin Oral Investig. 2021; 25 (12): 6517-6531.
3. Joda et al., Digital technology in fixed implant prosthodontics. Periodontol 2000. 2000; 73 (1): 178-192.
4. Wismeijer et al. Group 5 ITI consensus report: digital technologies. Clin Oral Implants Res. 2018; 29 (Suppl 16): 436-442.
5. Flügge et al., The accuracy of different dental impression techniques for implant-supported dental prostheses: a systematic review and meta-analysis. Clin Oral Implants Res. 2018; 29 (Suppl 16): 374-392.
6. Paratelli A, Vania S, Gómez-Polo C, Ortega R, Revilla-León M, Gómez-Polo M. Techniques to improve the accuracy of complete arch implant intraoral digital scans: a systematic review. J Prosthet Dent. 2023; 129 (6): 844-854.
7. Andriessen et al., Applicability and accuracy of an intraoral scanner for scanning multiple implants in edentulous mandibles: a pilot study. J Prosthet Dent. 2014; 111 (3): 186-194.
8. Revilla-León et al., Intraoral digital implant scans: parameters to improve accuracy. J Prosthodont. 2023; 32 (S2): 150-164.
9. Chen et al., Understanding the effect of scan spans on the accuracy of intraoral and desktop scanners. J Dent. 2022; 124:104220.
10. Rutkunas et al., The effect of different implant impression splinting techniques and time on the dimensional accuracy: an in vitro study. J Dent. 2022; 126:104267.
11. Gómez-Polo et al., Accuracy, scanning time, and patient satisfaction of stereo-photogrammetry systems for acquiring 3D dental implant positions: a systematic review. J Prosthodont. 2023; 32 (S2): 208-224.
12. Hussein MO. Photogrammetry technology in implant dentistry: a systematic review. J Prosthet Dent Published online. 2023; 130 (3): 318-326.
13. Cheng et al., Accuracy of edentulous full-arch implant impression: an in vitro comparison between conventional impression, intraoral scan with and without splinting, and photogrammetry. Clin Oral Implants Res. 2024; 35:560-572.
14. Revilla-León et al., Trueness and precision of complete-arch photogrammetry implant scanning assessed with a coordinate-measuring machine. J Prosthet Dent. 2023; 129 (1): 160-165.
15. Tallarico et al. Feasibility of using a prosthetic-based impression template to improve the trueness and precision of a complete arch digital impression on four and six implants: an in vitro study. Materials. 2020; 13 (16): 3543.
16. Pan et al., Improving intraoral implant scanning with a novel auxiliary device: an in-vitro study. Clin Oral Implants Res. 2021; 32 (12): 1466-1473.
17. Kernen F R, Recca M, Vach K, Nahles S, Nelson K, Flügge T V. In vitro scanning accuracy using different aids for multiple implants in the edentulous arch. Clin Oral Implants Res. 2022; 33 (10): 1010-1020.
18. Kernen et al. Enhancing intraoral scanner accuracy using scan aid for multiple implants in the edentulous arch: an in vivo study. Clin Oral Implants Res. 2023; 34 (8): 793-801.
19. Iturrate et al., Accuracy of digital impressions for implant-supported complete-arch prosthesis, using an auxiliary geometry part—an in vitro study. Clin Oral Implants Res. 2019; 30 (12): 1250-1258.
20. Gómez-Polo et al., Guided implant scanning: a procedure for improving the accuracy of implant-supported complete-arch fixed dental prostheses. J Prosthet Dent. 2020; 124 (2): 135-139.
21. Huang R et al., Improved scanning accuracy with newly designed scan bodies: an in vitro study comparing digital versus conventional impression techniques for complete-arch implant rehabilitation. Clin Oral Implants Res. 2020; 31 (7): 625-633.
22. Llansana et al., Calibrated splinting framework for complete arch intraoral implant digital scans manufactured by combining milled and additively manufacturing technologies: a dental technique. J Prosthet Dent. 2022; S0022-3913 (22): 00558-3.
23. Mizumoto et al., Accuracy of different digital scanning techniques and scan bodies for complete-arch implant-supported prostheses. J Prosthet Dent. 2020; 123 (1): 96-104.
24. Meneghetti et al., Influence of scanbody design and intraoral scanner on the trueness of complete arch implant digital impressions: an in vitro study. PLOS One. 2023; 18 (12): e0295790.
25. Papaspyridakos et al., Effect of splinted and nonsplinted impression techniques on the accuracy of fit of fixed implant prostheses in edentulous patients: a comparative study. Int J Oral Maxillofac Implants. 2011; 26 (6): 1267-1272.
26. Iturrate et al., Obtaining reliable intraoral digital scans for an implant-supported complete-arch pros-thesis: a dental technique. J Prosthet Dent. 2019; 121 (2): 237-241.
27. Kan et al., Clinical methods for evaluating implant framework fit. J Prosthet Dent. 1999; 81 (1): 7-13.
28. Pan et al., Implant framework misfit: a systematic review on assessment methods and clinical complications. Clin Implant Dent Relat Res. 2021; 23 (2): 244-258.
29. Jemt T, Book K. Prosthesis misfit and marginal bone loss in edentulous implant patients. Int J Oral Maxillofac Implants. 1996; 11 (5): 620-625.
30. Jemt et al., Measuring fit at the implant prosthodontic interface. J Prosthet Dent. 1996; 75 (3): 314-325.

All publications and patents mentioned in the above specification are herein incorporated by reference. Various modifications and variations of the described compositions and methods of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the present invention.

1. A method of generating a calibrated dental arch image comprising:
a) receiving intraoral scan data, wherein said intraoral scan data is generated by an intraoral scanner scanning a dental arch calibration jig:
i) on, and optionally attached to, at least part of an edentulous area of an dental arch of a subject that has a plurality of scan bodies attached to dental implants, or
ii) attached to a stackable base template that is attached to a stackable implant guide template, where said stackable base template is on, and attached to, said at least part of said edentulous area of said dental arch of said subject, or
iii) attached to said stackable implant guide,
wherein said intraoral scan data comprises a first library of images of said calibration jig, wherein at least some of said images of said calibration jig further comprise an image of at least one of said scan bodies;
b) inputting said intraoral scan data into a processing system comprising a database, wherein said database comprises 3D calibration scan data,
wherein said 3D calibration scan data is from a 3D scanner scanning said dental arch calibration jig, or replica thereof, and wherein said 3D calibration scan data comprises at least part of a 3D dental arch calibration jig image,
wherein said processing system further comprises: i) a computer processor, and ii) non-transitory computer memory comprising one or more computer programs,
c) processing said intraoral scan data and said 3D calibration scan data with said processing system such that said one or more computer programs, in conjunction with said computer processor:
i) stitches together at least some of said first library of images of said calibration jig to generate an stitched intraoral scan 3D jig image of at least a first region of said dental arch calibration jig, wherein said stitched intraoral scan 3D jig image comprises a plurality of stitching errors; and
ii) spatially aligning at least a portion of said stitched intraoral scan 3D jig image with said 3D dental arch calibration jig image to generate a calibrated dental arch image.

2. The method of claim 1, wherein:
a) said calibrated dental arch image comprises less than said plurality of stitching errors in said stitched intraoral scan 3D jig image, and optionally has 1.5× or 2.0× or 2.5× less stitching errors; and/or
b) said calibrated dental arch image has a linear deviation from said 3D dental arch calibration jig image of less than 50 μm, or less than 45 μm, when aligned by all of said plurality of scan bodies, and optionally wherein said plurality of scan bodies comprises at least 3, 4, 5, 6, 7, or 8 scan bodies; and/or
c) said calibrated dental arch image has a linear deviation from said 3D dental arch calibration jig image of less than 200 μm, or less than 150 μm, or less than 125 μm, when aligned by only two of said plurality of scan bodies.

3. The method of claim 1, wherein said stitched intraoral scan 3D jig image comprises an image of at least one of said scan bodies, and optionally an image of all of said scan bodies, and optionally only one of said scan bodies.

4. The method of claim 1, wherein said at least a first region of said dental arch calibration jig comprises all or substantially all of said dental arch calibration jig, or about 30-70% of said dental arch calibration jig.

5. The method of claim 4, wherein said stitched intraoral scan 3D jig image aligns to about ½, ¼^{th}, ⅙^{th} or ⅛^{th} of said 3D dental arch calibration jig image, which is optionally a full-arch image.

6. The method of claim 1, further comprising: d) merging said calibrated dental arch image with a second library of images of at least part of said edentulous area of said dental arch of said subject without said dental arch calibration jig in place on said subject such that a final merged image is generated, and optionally, wherein said second library comprises overlapping images of at least part of said edentulous area.

7. The method of claim 6, further comprising: e) employing said final merged image to generate dentures and/or an intraoral appliance, for said subject.

8. The method of claim 1, wherein said spatially aligns comprises realigning at least some of said first library of images of said calibration jig.

9. The method of claim 1, wherein said first library of images of said calibration jig comprises overlapping images of said calibration jig.

10. The method of claim 1, wherein said dental arch calibration jig has an outer surface bearing a non-repeating 3D pattern, and optionally wherein said non-repeating 3D pattern provides a unique reference point at areas along said dental arch calibration jig, and optionally wherein said unique reference points aid in said stitching together and/or said spatially aligns in step c).

11. The method of claim 1, wherein said dental arch calibration jig comprises a plurality of holes or cut-outs that align to said plurality of scan bodies attached to dental implants, and/or wherein said dental arch calibration jig comprises a plurality of pin holes that allow pins to be inserted therethrough to attach said dental arch calibration jig to said dental arch of said subject.

12. A processing system comprising:
a) a computer processor,
b) non-transitory computer memory comprising a database and one or more computer programs,
wherein said database comprises:
i) intraoral scan data that is from an intraoral scanner scanning a dental arch calibration jig:
A) on, and optionally attached to, at least part of an edentulous area of a dental arch of a subject that has a plurality of scan bodies attached to dental implants,
B) attached to a stackable base template that is attached to a stackable implant guide template, where said stackable base template is on, and attached to, said at least part of said edentulous area of said dental arch of said subject, or
C) attached to said stackable implant guide,
wherein said intraoral scan data comprises a first library of images of said calibration jig, wherein at least some of said images of said calibration jig further comprise an image of at least one of said scan bodies, and
ii) 3D calibration scan data that is from a 3D scanner scanning said dental arch calibration jig, or replica thereof, wherein said 3D calibration scan data comprises a 3D dental arch calibration jig image,
wherein said one or more computer programs, in conjunction with said processor and database, are configured to
i) stitch together at least some of said first library of images of said calibration jig to generate a stitched intraoral scan 3D jig image of at least a first region of said dental arch calibration jig, wherein said stitched intraoral scan 3D jig image comprises a plurality of stitching errors; and
ii) spatially align at least a portion of said stitched intraoral scan 3D jig image with said 3D dental arch calibration jig image to generate a calibrated dental arch image.

13. The system of claim 12, wherein:
a) said calibrated dental arch image comprises less than said plurality of stitching errors in said stitched intraoral scan 3D jig image, and optionally has 1.5× or 2.0× or 2.5× less stitching errors; and/or
b) said calibrated dental arch image has a linear deviation from said 3D dental arch calibration jig image of less than 50 μm, or less than 45 μm, when aligned by all of said plurality of scan bodies, and optionally wherein said plurality of scan bodies comprises at least 3, 4, 5, 6, 7, or 8 scan bodies; and/or
c) said calibrated dental arch image has a linear deviation from said 3D dental arch calibration jig image of less than 200 μm, or less than 150 μm, or less than 125 μm, when aligned by only two of said plurality of scan bodies.

14. A kit or system comprising:
a) a calibration jig shaped to match the curvature of a dental arch of a subject, and having an outer surface bearing a non-repeating 3D pattern; and
b) a computer memory device, wherein said computer device comprises:
i) intraoral scan data that is from an intraoral scanner scanning a dental arch calibration jig:
A) on at least part of, and optionally attached to, an edentulous area of a dental arch of a subject that has a plurality of scan bodies attached to dental implants,
B) attached to a stackable base template that is attached to a stackable implant guide template, where said stackable base template is on, and attached to, said at least part of said edentulous area of said dental arch of said subject, or
C) attached to said stackable implant guide,
wherein said intraoral scan data comprises a first library of images of said calibration jig, and wherein at least some of said images of said calibration jig further comprise an image of at least one of said scan bodies, and/or
ii) 3D calibration scan data that is from a 3D scanner scanning said dental arch calibration jig, or replica thereof, wherein said 3D calibration scan data comprises a 3D dental arch calibration jig image.

15. The kit or system of claim 14, wherein said dental arch calibration jig comprises at least three calibration jigs, and wherein each of said at least three calibration jigs are of a different size.

16. The kit or system of claim 14, wherein said subject is a human.

17-20. (canceled)
